(19) United States
(12) Patent Application Publication
(10) Pub. No.: US 2026/0167325 A1
(43) Pub. Date: Jun. 18, 2026

(54) FLIGHT CONTROL SYSTEM HAVING AN ELECTRIC ACTUATOR FOR CONTROLLING A HYDRAULIC SERVO CONTROL

(71) Applicant: AIRBUS HELICOPTERS, Marignane Cedex (FR)

(72) Inventors: Clément LETONNELIER, La Fare Les Oliviers (FR); Pascal IZZO, Berre L'Etang (FR)

(73) Assignee: AIRBUS HELICOPTERS, Marignane Cedex (FR)

(21) Appl. No.: 19/332,808

(22) Filed: Sep. 18, 2025

(30) Foreign Application Priority Data
Dec. 12, 2024 (FR) FR2413949

(51) Int. Cl. B64C 19/02; B64C 13/12; B64C 13/28

(52) U.S. Cl. CPC B64C 19/02; B64C 13/12; B64C 13/28

(57) ABSTRACT

An electric flight control system comprising an actuation subassembly, having three external duplex computers for controlling an electric actuator. The electric actuator has three stators electrically connected to three respective switching devices, the switching devices being electrically connected to a same internal simplex computer of the electric actuator, each switching device being connected to a respective external duplex computers, each switching device being configured to connect the internal simplex computer or respective external duplex computer to the associated stator, the internal simplex computer being self-monitored and communicating with the three external duplex computers.

### CROSS REFERENCE TO RELATED APPLICATION

This application claims priority to French patent application no. FR 24 13949 filed on December 12, 2024, the disclosure of which is incorporated in its entirety by reference herein.

### TECHNICAL FIELD

The present disclosure relates to a flight control system having an electric actuator for controlling a hydraulic servo control.

### BACKGROUND

An aircraft may comprise mobile aerodynamic control surfaces controlled by an electrical flight control system in order to steer the aircraft. Such aerodynamic control surfaces may comprise rotor blades, propeller blades, ailerons or rudders for example.

An electric flight control system may comprise a plurality of piloting command acquisition subassemblies for acquiring a piloting command. Each piloting command acquisition subassembly may be integrated into a piloting member that can be operated by a pilot, such as a control stick for example, in order to encode a command following the operation of the piloting member. Moreover, the flight control system comprises a processing subassembly determining a positional setpoint to be reached in order to position one or more aerodynamic control surfaces in the required manner as a function of at least one command encoded by a piloting command acquisition subassembly and the current situational state of the aircraft. Such a positional setpoint may be a pitch angle of a blade, a deflection angle of a flap or a speed of rotation of a rotor or propeller, for example. Finally, the flight control system comprises at least one actuating subassembly controlling an actuator acting on one or more aerodynamic control surfaces as a function of a positional setpoint determined by the processing subassembly.

Certification regulations impose, for such a flight control system, a failure occurrence rate less than or equal to 10⁻⁹/flight-hour, that leads to a failure occurrence rate less than or equal to 10⁻¹⁰/flight-hour for each subassembly.

In addition, equipment of the subassemblies of an electrical flight control system of an aircraft may be part of a Master Minimum Equipment List (MMEL). This list defines the list of equipment that may be inoperative for the flight, the conditions to be met to allow a flight in accordance with the objectives of the certification authorities and the number of days or hours of flight authorized from the discovery of the failure. This additional condition gives rise to other constraints and, in particular, leads to the attainment of a failure occurrence rate for the flight control system that is less than or equal to a value of between 10⁻⁷ and 10⁻⁸/flight-hour with failed reference item of equipment, i.e., a failure occurrence rate of the subassemblies that is less than or equal to a value of between 10⁻⁸ and 10⁻⁹/flight-hour with a failed reference item of equipment. It should be noted that an item of equipment for which the failure occurrence probability is less than an acceptability threshold, typically 10⁻⁵/flight-hour, is not considered. In other words, it is accepted that the failure of an item of equipment having a failure rate below the acceptability threshold leads to immobilization of the aircraft.

Consequently, each subassembly must therefore have a failure occurrence rate of 10⁻¹⁰/flight-hour under normal conditions and, where applicable, of 10⁻⁸ to 10⁻⁹/flight-hour under MMEL conditions, namely if the flight is authorized for a certain number of flight-hours in the event of failure of a reference item of equipment of the subassembly.

In particular, an electric flight control system may comprise an electric actuator with a movable power shaft for controlling a hydraulic servo control by moving a rod of the servo control relative to at least one body of the servo control. By way of example, a rotorcraft may comprise a plurality of fixed-body hydraulic servo-controls controlled by respective electric actuators, each servo control having a movable power rod articulated to a swashplate device, this swashplate device being articulated to at least one pitch change rod, each pitch change rod being articulated to a variable-pitch blade.

In this context, a conventional actuating subassembly may comprise an electric actuator provided with four stators for jointly moving a rotor member. Each stator is controlled by an associated actuation computer as a function of a positional setpoint to be reached, a relative position information between the stator and the rotor, measured using an associated position sensor, and a position of the servo control measured with an associated positional sensor of the servo control. Thus, the electric actuator comprises four stators controlled by four respective actuation computers, the electric actuator comprising four position sensors in communication respectively with the four actuation computers, the servo control comprising four position sensors in communication respectively with the four actuation computers. Each actuation computer is, moreover, a synchronous duplex computer.

The expression "duplex computer" refers here and hereinafter to a computer that has two independent calculation channels, the execution of which is synchronized, unlike a simplex computer that has only one calculation channel. The expression "calculation channel" refers to a digital and/or analog processing unit that makes it possible to perform calculations on quantities represented digitally and/or analogically. The processing unit can perform digital processing with a processor or other forms of integrated circuit including logic circuits. The processing unit may perform analog processing with analog components integrated or not in integrated circuits such as, for example, operational amplifiers. The term "processor" may refer equally to a central processing unit or CPU, a graphics processing unit or GPU, a digital signal processor or DSP, a microcontroller, etc. For example, a duplex computer may comprise two calculation channels each having a processor, whereas a simplex computer comprises a single calculation channel having, for example, one processor.

Such an actuation subsystem makes it possible to achieve a failure occurrence rate of less than or equal to 10⁻¹⁰/flight-hour under normal conditions, and 10⁻⁹/flight-hour under MMEL conditions, but requires large numbers of stators, computers and interconnection links, that can result in non-negligible cost, mass and/or size.

Document US 12024306 B2 does not belong to the technical field describing a hydraulic system comprising a first hydraulic actuator controlled by a first actuator control device and a second hydraulic actuator controlled by a second actuator control device. The actuation system is further provided with a shared redundant actuator control device and with at least one transfer device operatively connected to the above-mentioned actuator control devices.

The technological background of the disclosure comprises documents US 2018/0102721, US 2023/0227174 and US 2021/0099050.

### SUMMARY

An object of the present disclosure is therefore to propose an innovative electric flight control system capable of achieving a failure occurrence rate less than or equal to 10⁻¹⁰/flight-hour under normal conditions, and from 10⁻⁸ to 10⁻⁹/flight-hour under MMEL conditions.

The present disclosure relates to an electric flight control system for controlling a hydraulic servo control, said flight control system comprising a processing subassembly generating at least one positional setpoint, said flight control system comprising an actuating subassembly, said flight control system comprising an electric actuator for controlling the servo control, said electric actuator comprising a plurality of stators and a rotor member moved by this plurality of stators.

The actuating subassembly comprises three external duplex computers for controlling said electric actuator as a function of said at least one positional setpoint, said plurality of stators comprising only three stators electrically connected to three respective switching devices of the electric actuator, the switching devices being electrically connected to one and the same internal simplex computer of the electric actuator, each switching device being connected to one respective external duplex computers, each switching device being configured to connect to the associated stator the internal simplex computer or the respective external duplex computer, the internal simplex computer being self-monitored and communicating with the three external duplex computers.

The terms "external" and "internal" are used to distinguish the so-called "external" duplex computers present outside the electric actuator, from the simplex computer present inside the electric actuator.

The external duplex computers and the internal simplex computer are also dissimilar, in fact intrinsically but possibly also at the component level. For example, the processor of the simplex computer is different from the processors of the external duplex computers. Optionally, the external duplex computers are similar.

Thus, unlike a conventional flight control system having an electric actuator comprising four stators connected to four external computers, the electric actuator comprises only three stators for generating rotating magnetic fields enabling the rotor member to be set in motion.

In the nominal case, the three stators are respectively controlled by the three external duplex computers via the three switching devices. The internal simplex computer is then on active standby. This internal simplex computer ensures that the external duplex computers operate correctly by means of validity signals transmitted by the external duplex computers.

In the event of a failure of an external duplex computer, the associated stator is then controlled by the internal simplex computer, with the switching device connecting the internal simplex computer to the stator instead of the failed external duplex computer. This internal simplex computer has the particular features of being integrated directly into the electric actuator, and of using a self-monitored processing unit to ensure its integrity. Such an internal simplex computer can achieve a failure occurrence rate less than or equal to 10⁻⁵/flight-hour, that can enable the actuator to be removed from the list of reference equipment.

Such an electric actuator then makes it possible to use only a limited number of stators, sensors, and interconnection links in order to obtain an actuation subsystem having a failure occurrence rate less than or equal to 10⁻¹⁰/flight-hour under normal conditions, and from 10⁻⁸ to 10⁻⁹/flight-hour under MMEL conditions. Thus, such a flight control system may have optimized cost, weight, and/or size. The transition from four external duplex computers to three external duplex computers and a simplex internal computer integrated in the electric actuator offers a gain in terms of wiring, weight and volume, but also a more optimized cost due to the elimination of one external duplex computer while the integration of a simplex internal computer in the electric actuator has a limited financial impact.

The electric actuator may in addition have one or more of the following features, taken individually or in combination.

Thus each external duplex computer may comprise a control channel generating an external control signal as a function of at least said at least one positional setpoint, each external duplex computer comprising a monitoring channel generating a validity signal.

Each external duplex computer may be of a usual type for providing the control signal and the validity signal.

For example, said electric actuator may comprise three primary position sensors each measuring an angular position of the rotor member, the three primary position sensors being connected respectively to the three external duplex computers, each external duplex computer being configured to generate an external control signal as a function at least of said at least one positional setpoint and of said angular position.

The external duplex computers then control the electrical supply to the stators as a function of at least the positions measured by the primary position sensors. Only three primary position sensors are then necessary. This feature may optimize the cost, mass, and/or size of the system.

The control channel may, for example, generate the control signal by applying a stored law giving the characteristics of the control signal as a function at least of the positional setpoint and the angular position received.

Optionally, each external duplex computer may be configured to receive a current position of a member of the servo control, each external duplex computer being configured to generate an external control signal as a function of said at least one positional setpoint and said angular position as well as the current position.

According to one possibility compatible with the preceding possibilities, each switching device may be connected to the control channel and to the monitoring channel of the corresponding external duplex computer, each switching device being connected to the internal simplex computer so as to be able to receive an internal control signal and a selection signal emitted by this internal simplex computer, each switching device being configured to transmit the internal control signal or the external control signal to the corresponding stator as a function of the selection signal and the validity signal.

Such a switching device thus proves to be simple and effective.

Each switching device is thus controlled by the associated external duplex computer and by the internal simplex computer in order to transmit, to the stator, either the internal control signal or the external control signal. The switching from the external duplex computer to the internal simplex computer for controlling the electrical supply of a stator is based on the validity state of the external duplex computer transmitted via the validity signal. This validity signal is generated by the external duplex computer in a conventional manner, for example from internal integrity elements and after consolidation between the control and monitoring calculation channels.

Moreover, the switching from the external duplex computer to the internal simplex computer for a stator is also based on the selection signal. The internal simplex computer can emit, for each switching device, a selection signal based on the validity signals emitted by the external duplex computers and its own integrity state. The internal simplex computer can ensure that only one selection signal is emitted at a time.

For example, each switching device may comprise a first switch and a fourth switch connected in series to the control channel of the corresponding external duplex computer and to the corresponding stator, each switching device comprising a second switch and a third switch connected in series to the internal simplex computer in order to be able to receive the internal control signal and to the corresponding stator, the first switch and the fourth switch being electrically connected to the monitoring channel of the corresponding external duplex computer to be each placed in an open or closed state as a function of the received validity signal, the second switch being electrically connected, optionally via an inverting gate, to the monitoring channel of the corresponding external duplex computer, in order to be placed in an open or closed state as a function of the received validity signal, the third switch being electrically connected to the internal simplex computer in order to be able to receive the selection signal in order to be placed in an open or closed state depending on the received selection signal.

The switches enable the switching device to transmit either the internal control signal or the external control signal to the associated stator. Each switch may, for example, take the form of a relay, a MOSFET transistor, or the like. In particular, the transmission of the external control signal emitted by an external duplex computer to a stator passes through the first switch and the fourth switch, both controlled by the validity signal emitted by this external duplex computer, in order to ensure that in the event of a short-circuit failure of the first or fourth switch, followed by an invalidity of the external duplex computer, the switching mechanism does not interconnect the command emitted by the external duplex computer with the command emitted by the internal simplex computer.

According to one possibility compatible with the preceding possibilities, the internal simplex computer may comprise three external validation connections, connected respectively to the three external duplex computers in order to receive a validity signal emitted by each external duplex computer, the internal simplex computer being configured to emit to each switching device a selection signal as a function at least of the validity signal emitted by the external duplex computer in communication with this switching device.

The validity signal emitted by an external duplex computer may in particular be emitted by its monitoring calculation channel, or its control calculation channel.

The internal simplex computer may be configured to evaluate the validity of the control signals using the validity signals in a conventional manner. The internal simplex computer then emits a selection signal as soon as a validity signal carries a piece of information indicating that the associated duplex computer is malfunctioning, in order to control the stator concerned. The internal simplex computer can be configured to take control of a single stator, i.e., in place of the first computer deemed defective among the duplex computers.

According to one possibility compatible with the preceding possibilities, the internal simplex computer may comprise a single calculation channel provided with a microprocessor or a microcontroller, having a first core and a second core configured to perform the same operations in parallel.

According to one possibility compatible with the preceding possibilities, said electric actuator comprises a first and a second secondary position sensor each measuring an angular position of the rotor member, said internal simplex computer comprising an external control connection connected to the processing subassembly to receive a positional setpoint, said internal simplex computer comprising a positional connection receiving a current position of a member of the servo control, said internal simplex computer comprising a first core configured to determine a first intermediate order as a function of the positional setpoint as well as the current position and the angular positions transmitted by the first secondary position sensor and the second secondary position sensor, the internal simplex computer comprising a second core configured to determine a second intermediate order as a function of the positional setpoint as well as the current position and the angular positions transmitted by the first secondary position sensor and the second secondary position sensor, said internal simplex computer being configured to consolidate a final order using the first order and the second order, said internal simplex computer emitting, to each switching device, an internal control signal carrying said final order.

The use of two secondary position sensors makes it possible to take into consideration the slight deformation of the rotor member that may be caused in operation by the stators. Optionally, with the rotor member extending from a first end to a second end, the two secondary position sensors may be arranged at the first end and the second end, respectively.

According to an alternative, the first core and the second core can perform a consistency check between them, in order to guarantee the integrity of the calculations. If this consistency check makes it possible to conclude that the first and second orders are consistent, the final order may for example be equal to one of the first and second orders, or to an average of the first and second orders, for example. Otherwise, the internal simplex computer may be rendered inoperative.

According to another alternative, the internal simplex computer may take the form of a dual-core processing unit, known as "lockstep", in order to ensure the integrity of the calculations. Such a unit may comprise a microcontroller or a component known by the acronym "SoC" and the expression "System on a chip" having the first and second cores and at least one peripheral device, including a usual peripheral device for managing consistency between the operations performed by the cores. This device checks that the execution flows on the two cores are identical and that the results are also identical. If this is not the case, the internal simplex computer is invalidated. On the other hand, if this is the case, the final order may be equal to one of the first and second orders, for example.

The disclosure also relates to an aircraft provided with an aerodynamic control surface mechanically connected by a mechanical link to a hydraulic servo control. The aircraft comprises a flight control system according to the disclosure, said rotor member of the actuator being kinematically connected to a hydraulic distributor of the servo control.

Optionally, the internal simplex computer and the external duplex computers may be electrically connected to respective positional sensors of the servo control.

### BRIEF DESCRIPTION OF THE DRAWINGS

The disclosure and its advantages appear in greater detail from the following description of examples given by way of illustration with reference to the accompanying figures, wherein:

FIG. 1 shows a view of an aircraft having an electric flight control system comprising an electric actuator according to the disclosure; and

FIG. 2 is a view of a switching device according to the disclosure.

### DETAILED DESCRIPTION

Elements present in more than one of the figures are given the same references in each of them.

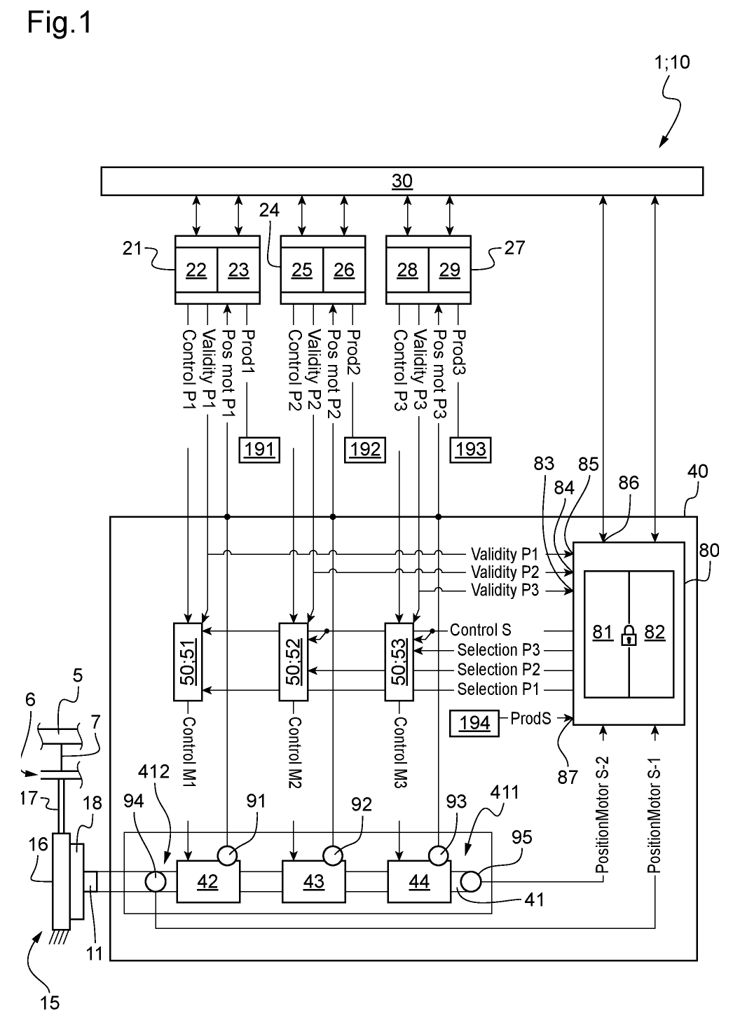

FIG. 1 shows an aircraft 1 provided with at least one aerodynamic control surface 5 having an adjustable position for steering this aircraft 1. The position of the aerodynamic control surface 5 can be modified by a hydraulic servo control 15.

For this purpose, the servo control 15 is connected by a mechanical link to the aerodynamic control surface 5. Such a hydraulic servo control 15 may conventionally comprise a hydraulic distributor 18, as well as at least one body 16 and one power rod 17 that are movable relative to one another under the effect of the circulation of a hydraulic fluid conveyed in the hydraulic distributor 18.

According to the example of FIG. 1, the aircraft 1 is a rotorcraft comprising a rotor provided with a variable-pitch blade 5. This example comprises a servo control 15 having a fixed body 16 and a power rod 17 articulated to a swashplate device 6, at least one pitch change rod 7 being articulated to the blade 5 and to this swashplate device 6. According to another example, an aerodynamic control surface 5 may, for example, be in the form of a movable flap.

Furthermore, the hydraulic servo control 15 is controlled by an electric flight control system 10.

The electric flight control system 10 comprises a processing subassembly 30 generating at least one positional setpoint, to be reached in order to position the aerodynamic control surface in the required manner, and an actuating subassembly controlling an electric actuator 40 as a function of said at least one positional setpoint.

This electric actuator 40 is provided with a plurality of stators 42, 43, 44 and a rotor member 41 moved by a plurality of stators 42, 43, 44. The rotor member 41 is mechanically connected to a lever 11 of the hydraulic distributor 18 of the servo control 15. Thus, a rotation of this rotor member 41 under the effect of magnetic fields induces a stress on the hydraulic distributor 18 to extend or retract the servo control 15. The electric actuator 40 and the servo control 15 may form one and the same piece of equipment, or two separate pieces of equipment.

This electric actuator 40 is connected to three external duplex computers 21, 24, 27 of the actuating subassembly. In addition, the three external duplex computers 21, 24, 27 and the electric actuator 40 are all connected to the processing subassembly 30 so that the electric actuator 40 is controlled as a function of each positional setpoint generated by the processing subassembly 30.

Thus, the processing subassembly 30 conventionally comprises one or more computers configured to generate and transmit at least one positional setpoint to the three external duplex computers 21, 24, 27 and to the electric actuator 40. If several positional setpoints relating to the same parameter are emitted by redundant computers, the three external duplex computers 21, 24, 27 and the electric actuator 40 can be configured to use one of the positional setpoints by applying a conventional selection method. For example, this positional setpoint relates to a position that the power rod 17 must reach relative to the body 16, or vice versa in the context of a servo control 15 with a mobile body.

Therefore, each external duplex computer 21, 24, 27 conventionally generates an external control signal ControlP1, ControlP2, ControlP3 and a validity signal ValidityP1, ValidityP2, ValidityP3 as a function at least of the one or more positional setpoints received.

For this purpose, the three external duplex computers 21, 24, 27 each have a control calculation channel 22, 25, 28 generating the external control signal ControlP1, ControlP2, ControlP3 and a monitoring calculation channel 23, 26, 29 generating the validity signal ValidityP1, ValidityP2, ValidityP3. The control calculation channel 22, 25, 28 and the monitoring calculation channel 23, 26, 29 of the same duplex external computers 21, 24, 27 can be independent and synchronized.

For example, the control calculation channel 22, 25, 28 of each external duplex computer 21, 24, 27 is configured to generate a, for example analog, control signal, transmitted to the electric actuator 40 and to its monitoring calculation channel 23, 26, 29. Moreover, the monitoring calculation channel 23, 26, 29 of an external duplex computer 21, 24, 27 is configured to verify that the control calculation channel 22, 25, 28 of this same external duplex computer 21, 24, 27 is operating correctly, for example by performing calculations that should lead to the same result as the result carried by the control signal. The monitoring calculation channel 23, 26, 29 then emits a, for example analog, validity signal ValidityP1, ValidityP2, ValidityP3, indicating whether the associated control calculation channel 22, 25, 28 is operating correctly or malfunctioning.

To enable the external duplex computers 21, 24, 27 to generate the control signals and the validity signals, the electric actuator 40 may comprise three primary position sensors 91, 92, 93 each measuring an angular position of the rotor member 41, for example at the location of associated stator. The three primary position sensors 91, 92, 93 are respectively connected to the three external duplex computers 21, 24, 27 to respectively transmit to them three measurement signals PosMot P1, PosMot P2, PosMot P3. Optionally, the external duplex computers 21, 24, 27 are further connected to respective positional sensors 191, 192, 193 of the servo control 15, each measuring a situational position of the servo control 15. Each positional sensor 191, 192, 193 can measure a position of the power rod 17 relative to the body 16 for example, and transmit it by means of a rod position signal Prod1, Prod2, Prod3.

Thus, each control calculation channel 22, 25, 28 of an external duplex computer 21, 24, 27 may apply a law stored in memory, to emit an external control signal that is a function of the positional setpoint received, or even of the angular position received and/or of the situational position received. Similarly, each monitoring calculation channel 23, 26, 29 can take these parameters into account to evaluate the operation of the control calculation channel 22, 25, 28 of its external duplex computer.

Independently of these aspects, the electric actuator 40 is provided with a rotor member 41 that is moved by rotating magnetic fields generated by three stators 42, 43, 44. The three stators 42, 43, 44 are electrically connected respectively to three switching devices 50 of the electric actuator 40. Reference 50 refers to any switching device, while references 51, 52 and 53 each refer to a particular switching device if required.

The switching devices 50 are each connected to the control channel 22, 25, 28 and to the monitoring channel 23, 26, 29 of the corresponding external duplex computer 21, 24, 27. Thus, a first stator 42 is electrically connected to a first switching device 51 that is connected to the calculation channels 22, 23 of a first external duplex computer 21, a second stator 43 is electrically connected to a second switching device 52 that is connected to the calculation channels 25, 26 of a second external duplex computer 24, and a third stator 44 is electrically connected to a third switching device 53 that is connected to the calculation channels 28, 29 of a third external duplex computer 27.

In addition, the switching devices 50 are all electrically connected to a common internal simplex computer 80 of the electric actuator 40. Therefore, each switching device 50 is configured to connect, at each instant, to the associated stator 42, 43, 44, the internal simplex computer 80 or the respective external duplex computer 21, 24, 27, and thus transmit a signal ControlM1, ControlM2, ControlM3 to this stator.

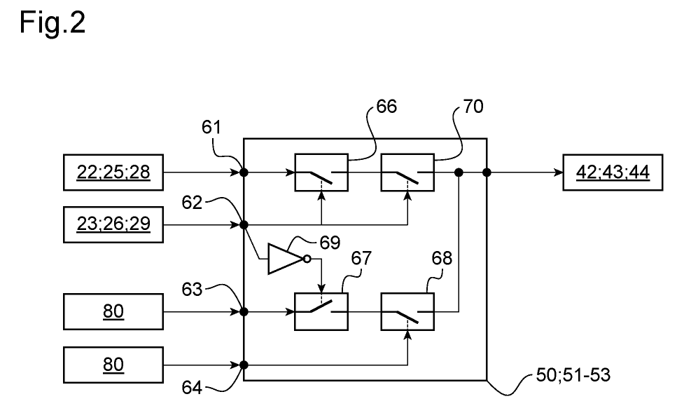

FIG. 2 illustrates such a switching device 50.

Thus, each switching device 50 has a first switch 66 and a fourth switch 70 connected in series to the control channel 22, 25, 28 of the corresponding external duplex computer 21, 24, 27, for example via a first socket 61 of the electric actuator 40. When the first switch 66 and the fourth switch 70 are closed, this first switch 66 and this fourth switch 70 thus transmit, to the corresponding stator 42, 43, 44, an external control signal ControlP1, ControlP2, ControlP3 emitted by the control calculation channel 22, 25, 28 of the associated external duplex computer 21, 24, 27. For this purpose, the first switch 66 and the fourth switch 70 are electrically connected to the monitoring channel 23, 26, 29 of the corresponding external duplex computer 21, 24, 27, for example via a second socket 62 of the electric actuator 40, to be placed in a closed state if the received validity signal ValidityP1, ValidityP2, ValidityP3 indicates that the control calculation channel 22, 25, 28 is operating correctly, or in an open state if not.

In addition, each switching device 50 has a second switch 67 and a third switch 68, electrically in series firstly with the internal simplex computer 80, for example via a third socket 63 of the electric actuator 40 so as to be able to receive an internal control signal ControlS, and secondly with the corresponding stator 42, 43, 44.

The second switch 67 is electrically connected to the monitoring channel 23, 26, 29 of the corresponding external duplex computer 21, 24, 27, optionally via an inverting gate 69, or even the second socket 62 of the electric actuator 40, in order to be placed in an open state if the validity signal ValidityP1, ValidityP2, ValidityP3 indicates that the corresponding control signal is valid, and closed if not. Finally, the third switch 68 is electrically connected to a connection of the internal simplex computer 80 transmitting a selection signal SelectionP1, SelectionP2, SelectionP3, for example via a fourth socket 64 of the electric actuator 40, in order to be placed in an open state if the selection signal SelectionP1, SelectionP2, SelectionP3 received indicates that the corresponding control signal is valid, and closed if not.

Consequently, if the transmitted control signal is valid, the first switch 66 and the fourth switch 70 are closed while the second switch 67 and the third switch 68 are open, that allows the external control signal emitted by the associated external duplex computer 21, 24, 27 to be transmitted to the stator 42, 43, 44. Conversely, if the control signal transmitted is invalid, the first switch 66 and the fourth switch 70 are open while the second switch 67 and the third switch 68 are closed, that allows the internal control signal ControlS emitted by the simplex internal computer 80 to be transmitted to the stator 42, 43, 44.

In order to control the switching devices 50 and with reference to FIG. 1, the internal simplex computer 80 has three external validation connections 83, 84, 85 respectively connected to the three monitoring calculation channels 23, 26, 29 to receive the validity signals ValidityP1, ValidityP2, ValidityP3 emitted by the corresponding external duplex computer 21, 24, 27.

The internal simplex computer 80 is configured to emit, if necessary, to each switching device 50, the respective selection signal SelectionP1, SelectionP2, SelectionP3 as a function at least of the validity signal ValidityP1, ValidityP2, ValidityP3 emitted by the external duplex computer 21, 24, 27 in communication with this switching device 50. If a validity signal indicates that the external duplex computer 21, 24, 27 concerned is defective, then the internal simplex computer 80 emits the associated selection signal to the switching device 50 concerned.

In addition, this internal simplex computer 80 is self-monitored. Thus, the internal simplex computer 80 may comprise a single calculation channel provided with a microprocessor or a microcontroller, having a first core 81 and a second core 82 configured to perform the same operations in parallel.

In addition, the electric actuator 40 may comprise first and second secondary position sensors 94, 95, each measuring an angular position of the rotor member 41 by respectively transmitting, to the internal simplex computer 80, the measurements PositionMotorS-1 and PositionMotorS-2. Since the rotor member 41 extends from a first end 411 to a second end 412, the two secondary position sensors 94, 95 may be arranged at the first end 411 and the second end 412, respectively.

Optionally, the internal simplex computer 80 may comprise an external control connection 86 connected to the processing subassembly 30 to receive a positional setpoint to be reached, and a positional connection 87 connected to a positional sensor 194 receiving a current position ProdS of a member of the servo control 15, and according to the example described above, of the power rod 17 relative to the body 16.

The first core 81 may then be configured to determine, for example using a stored law, a first intermediate order as a function of the positional setpoint or even the current position and the PositionmotorS-1 and PositionmotorS-2 measurements transmitted by the first secondary position sensor 94 and the second secondary position sensor 95. Similarly, the second core 82 is configured to determine, for example using a stored law, a second intermediate order as a function of the positional setpoint or even the current position and the PositionmotorS-1 and PositionmotorS-2 measurements transmitted by the first secondary position sensor 94 and the second secondary position sensor 95.

Optionally, the first core 81 and the second core 82 communicate with each other to consolidate a final order using the first order and the second order. For example, the final order may be one of the first order and second order if a difference between the first order and the second order is less than a limit, or may be an average of the first order and second order according to another possibility. The internal simplex computer 80 then emits, to each switching device 50, the internal control signal ControlS carrying said final order.

According to another possibility, the internal simplex computer 80 may comprise a consistency management peripheral device for evaluating the consistency of the calculations.

Thus, under nominal conditions, the switching devices 50 transmit an external control signal, for example an analog signal, coming from the associated external duplex computer 21, 24, 27, to the associated stator 42, 43, 44. If one of the external duplex computers 21, 24, 27 is judged to be defective, then the validity signal emitted by the defective external duplex computer 21, 24, 27 and the corresponding selection signal change in order that the switching device 50 no longer transmits the erroneous external control signal to the stator 42, 43, 44, but instead the internal control signal.

Naturally, the present disclosure may be subjected to numerous variations as to its implementation. Although several embodiments are described above, it should readily be understood that it is not conceivable to identify exhaustively all the possible embodiments. It is of course possible to replace any of the means described with equivalent means without going beyond the ambit of the present disclosure.

1. An electric flight control system for controlling a hydraulic servo control, the electric flight control system comprising a processing subassembly generating at least one positional setpoint, the electric flight control system comprising an actuating subassembly, the electric flight control system comprising an electric actuator for controlling the servo control, the electric actuator comprising a plurality of stators and a rotor member moved by the plurality of stators,
wherein the actuating subassembly comprises three external duplex computers for controlling the electric actuator as a function of the at least one positional setpoint, the plurality of stators comprising only three stators electrically connected to three respective switching devices of the electric actuator, the switching devices being electrically connected to one and the same internal simplex computer of the electric actuator, each switching device being connected to one respective external duplex computers, each switching device being configured to connect to the respective stator the internal simplex computer or the respective external duplex computer, the internal simplex computer being self-monitored and communicating with the three external duplex computers.

2. The electric flight control system according to claim 1,
wherein each external duplex computer comprises a control channel generating an external control signal as a function of at least the at least one positional setpoint, each external duplex computer comprising a monitoring channel generating a validity signal.

3. The electric flight control system according to claim 2,
wherein the electric actuator comprises three primary position sensors each measuring an angular position of the rotor member, the three primary position sensors being connected respectively to the three external duplex computers, each external duplex computer being configured to generate an external control signal as a function at least of the at least one positional setpoint and of the angular position.

4. The electric flight control system according to claim 3,
wherein each external duplex computer is configured to receive a current position of a member of the servo control, each external duplex computer being configured to generate the external control signal as a function of the at least one positional setpoint and the angular position as well as the current position.

5. The electric flight control system according to claim 2,
wherein each switching device is connected to the control channel and to the monitoring channel of the corresponding external duplex computer, each switching device being connected to the internal simplex computer to receive an internal control signal and a selection signal emitted by this internal simplex computer, each switching device being configured to transmit the internal control signal or the external control signal to the corresponding stator as a function of the selection signal and the validity signal.

6. The electric flight control system according to claim 5,
wherein each switching device comprises a first switch and a fourth switch connected in series to the control channel of the corresponding external duplex computer and to the corresponding stator, each switching device comprising a second switch and a third switch connected in series to the internal simplex computer to receive the internal control signal and to the corresponding stator, the first switch and the fourth switch being electrically connected to the monitoring channel of the corresponding external duplex computer to be each placed in an open or closed state as a function of the received validity signal, the second switch being electrically connected to the monitoring channel of the corresponding external duplex computer in order to be placed in an open or closed state as a function of the received validity signal, the third switch being electrically connected to the internal simplex computer to receive the selection signal in order to be placed in an open or closed state depending on the received selection signal.

7. The electric flight control system according to claim 1,
wherein the internal simplex computer comprises three external validation connections connected respectively to the three external duplex computers in order to receive a validity signal emitted by each external duplex computer, the internal simplex computer being configured to emit, to each switching device, a selection signal as a function at least of the validity signal emitted by the external duplex computer in communication with this switching device.

8. The electric flight control system according to claim 1,
wherein the internal simplex computer comprises a single calculation channel provided with a microprocessor or a microcontroller, having a first core and a second core configured to perform the same operations in parallel.

9. The electric flight control system according to claim 1,
wherein the electric actuator comprises a first and a second secondary position sensor each measuring an angular position of the rotor member, the internal simplex computer comprising an external control connection connected to the processing subassembly to receive the at least one positional setpoint positional setpoint, the internal simplex computer comprising a positional connection receiving a current position of a member of the servo control, the internal simplex computer comprising a first core configured to determine a first intermediate order as a function of the at least one positional setpoint positional setpoint as well as the current position and the angular positions transmitted by the first secondary position sensor and the second secondary position sensor, the internal simplex computer comprising a second core configured to determine a second intermediate order as a function of the positional setpoint as well as the current position and the angular positions transmitted by the first secondary position sensor and the second secondary position sensor, the internal simplex computer being configured to consolidate a final order using the first order and the second order, the internal simplex computer emitting, to each switching device, an internal control signal carrying the final order.

10. The electric flight control system according to claim 9,
wherein when the rotor member extends from a first end to a second end, the two secondary position sensors are arranged at the first end and the second end, respectively.

11. An aircraft provided with an aerodynamic control surface mechanically connected by a mechanical link to a hydraulic servo control,
wherein the aircraft comprises an electric flight control system according to claim 1, the rotor member of the actuator being kinematically connected to a hydraulic distributor of the servo control.

12. The aircraft according to claim 11,
wherein the internal simplex computer and the external duplex computers are electrically connected to respective positional sensors of the servo control.
